(19) United States
(12) Patent Application Publication
(10) Pub. No.: US 2010/0037897 A1
(43) Pub. Date: Feb. 18, 2010

(54) Nasal CPAP securement system

(75) Inventor: Tom Wood, Waycross, GA (US)

Correspondence Address: BRETT J. TROUT, PC, 516 WALNUT, DES MOINES, IA, 50309, US

(73) Assignee: RemGenic LLC

(21) Appl. No.: 12/228,603

(22) Filed: Aug. 14, 2008

(51) Int. Cl. A62B 18/08

(52) U.S. Cl. 128/207.11

(57) ABSTRACT

A nasal CPAP securement system which allows the gas delivery tube to swivel relative to the nasal cannula provided in the user's nose. The swivel connection allows the user to maintain multiple positions comfortably during sleep. The swivel also prevents the nasal cannula or nose pillows from becoming inadvertently dislodged during sleep.

### BACKGROUND OF THE INVENTION

1. Field of the Invention

This invention relates in general to a continuous positive airway pressure (CPAP) securement system and, more particularly, to a CPAP securement system which provides a swivel connection of the gas delivery system to the user's head.

2. Description of the Prior Art

Normally, when a person sleeps the person is able to maintain an adequate flow of air and, therefore, oxygen to the lungs. In certain individuals the airway may become blocked at night, thereby reducing the supply of oxygen to the blood and preventing the efficient removal of carbon dioxide from the lungs. Systems are often designed to deliver air, oxygen and/or additional gases to the patient at a controlled pressure. The gases may be supplied through the patient's mouth and/or nose.

It is important to maintain a sufficient seal around the orifice through which the gases are to be delivered. This seal insures that a constant and sufficient pressure is maintained to prevent the flow of gases into and out of the patient's lunch from becoming compromised. While masks covering the patient's nose and mouth are capable of providing a sufficient seal through the use of straps securing the mask in place, such masks are often obtrusive, uncomfortable and may prevent the patient from selecting a desired sleeping position without dislodging the mask.

Nasal cannulae are also well known in the art and are much less obtrusive than their full-mask counterparts. While nasal cannulae may provide a sufficient flow of gas to the patient, it is often difficult to provide a seal around the cannula sufficient to deliver a constant and sufficient gas pressure to maintain a patient's airway open. Additionally, even if the cannulae are attached so as to provide a sufficient seal around to the patient's nares, this seal may become compromised if the patient turns or moves their head during sleep. An additional drawback associated with the prior art is that the fixed placement of the cannulae and the tube delivering the gas to the cannulae often makes desired sleeping positions uncomfortable or unattainable for CPAP patients.

Accordingly, it would be desirable to provide a CPAP cannula securement system which was comfortable and adjustable, and which allowed the cannulae to be secured to the patient with a sufficient seal around the cannulae. It would additionally be desirable to provide a CPAP nasal cannulae system which allowed the user to adjust the gas supply tube supplying the cannula, while maintaining the positive securement of the cannula to the nose system to allow for multiple desired sleeping positions. The difficulties encountered in the prior art discussed hereinabove are substantially eliminated by the present invention.

### SUMMARY OF THE INVENTION

The instant invention discloses a nasal CPAP securement system with a headgear provided with a swivel securement system which allows a gas supply tube to be swivelly coupled to a user while the user is receiving continuous positive airway pressure through nasal cannulae. Accordingly, it is an object of the present invention to provide a nasal CPAP securement system which is of a low cost, lightweight manufacture.

It is yet another object of the present invention to provide a nasal CPAP securement system which is adjustable for use with various patients.

It is a further object of the present invention to provide a CPAP securement system which is easy to secure to a patient.

It is another object of the present invention to provide a nasal CPAP securement system which may be easily removed from a patient when desired.

It is another object of the present invention to provide a nasal CPAP securement system which reduces the likelihood of a nasal cannula becoming inadvertently dislodged from a patient during sleep.

It is a further object of the present invention to provide a nasal CPAP securement system which allows a user to adopt additional desired sleeping positions while maintaining a continuous positive airway pressure flow through a nasal cannula.

Other objects and benefits of this invention will become obvious from the description below when viewed in association with the accompanying drawings which set forth by way of illustration and example, rather than limitation, preferred embodiments of the present invention.

### BRIEF DESCRIPTION OF THE DRAWINGS

The present invention will now be described, by way of example, with reference to the accompanying drawings in which:

FIG. 1 illustrates a front perspective view in partial phantom of the nasal CPAP cannula securement system of the present invention secured to a user;

FIG. 2 illustrates a side perspective view of the swivel connector of the present invention;

FIG. 3 illustrates a side elevation in cross-section of the rack and ratchet system of the headgear of the present invention; and

FIG. 4 illustrates a side elevation in cross-section of the ball and cage securement system of the present invention.

### DETAILED DESCRIPTION OF THE PREFERRED EMBODIMENT

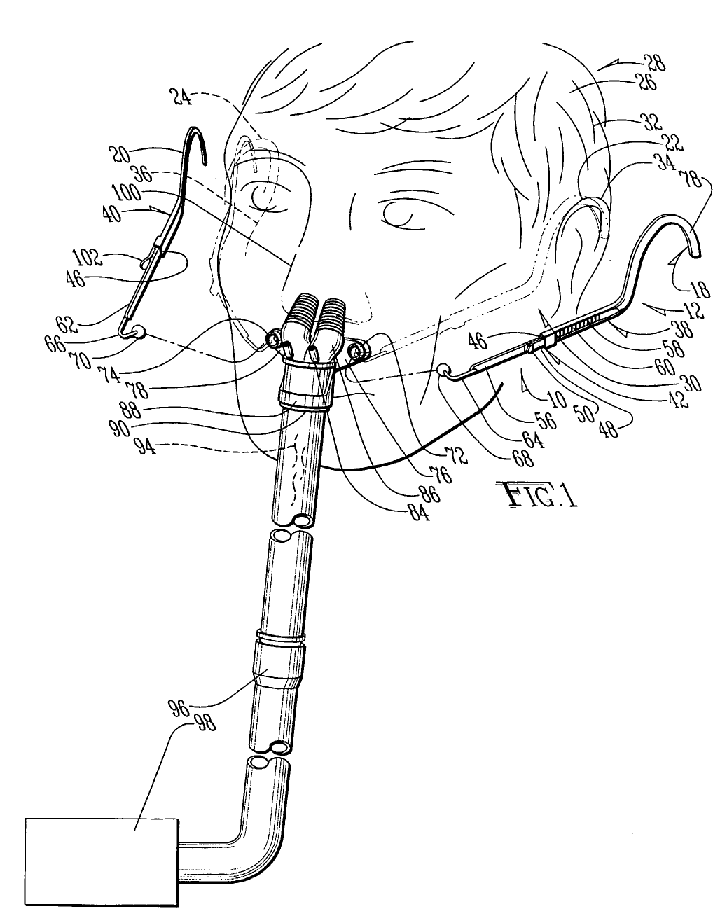

A continuous positive airway pressure (CPAP) headgear securement system is shown generally as (10) in FIG. 1. The system (10) includes a headgear (12) and a supply tube keeper (14). The headgear (12) is preferably constructed of a rigid plastic material, such as ABS. Although the headgear (12) may be of any desired construction, in the preferred embodiment the headgear (12) includes a rear head support (16) integrally molded with a first over-the-ear support (18) and a second over-the-ear support (20). The rear head support (16) is positioned below the tops (22) and (24) of the ear supports (18) and (20), and when positioned on the head (26) of a user (28) the rear head support (16) is positioned just below the base (30) of the cranium (32). The headgear (12) is preferably rigid enough to support the supply tube keeper (14) against substantial movement relative to the headgear (12) but flexible enough to stretch around the head (26) of the user (28) and to provide comfortable support around the ears (34) and (36) of the user (28).

The headgear (12) is preferably less than five millimeters thick, more preferably less than three millimeters thick and, most preferably, approximately two millimeters thick. The headgear (12) is preferably between two and fifteen millimeters high, more preferably between four and twelve millimeters high and, most preferably, approximately eight millimeters high. The headgear (12) is also preferably rigid enough to support itself against the weight of gravity.

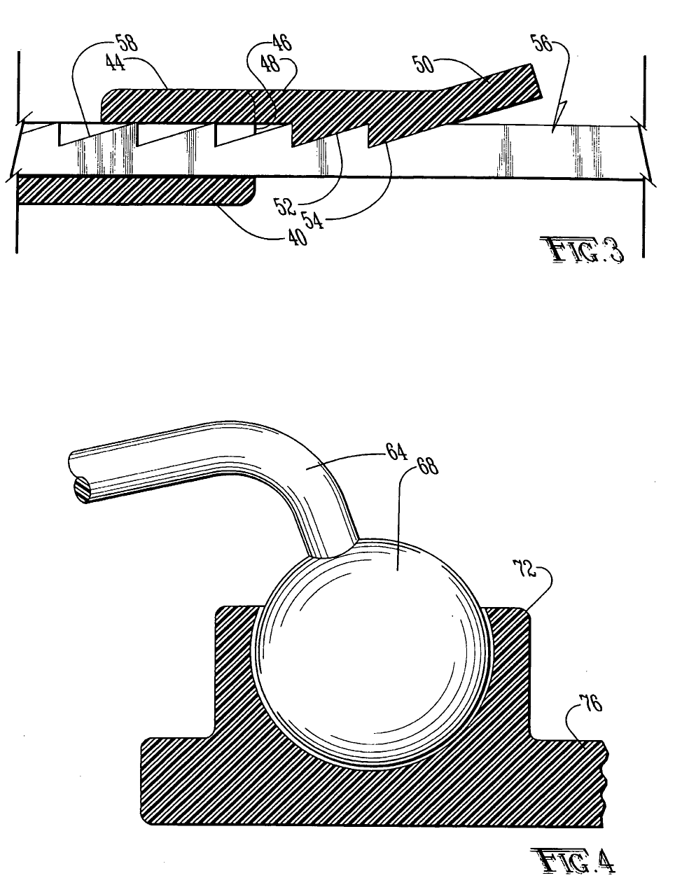

As shown in FIG. 1, a first support shoulder (38) and a second support shoulder (40) are integrally molded with the ear supports (18) and (20). Keepers, such as ratchets (42) and (44), are integrally formed with the support shoulders (38) and (40). As shown in FIG. 3, the ratchet (44) is secured to the support shoulder (40) in a manner which defines an opening (46). Provided through the opening (46), the ratchet (44) is constructed of a resilient material and constructed with a cantilevered overhand (48) with an angled tab (50). Provided beneath the cantilevered portion (48) are one or more teeth (52) and (54).

Also as shown in FIG. 3 is a telescopic arm (56) provided through the opening (46) in the support shoulder. The telescopic arm (56) is provided with a rack (58) which includes a plurality of teeth (60). Preferably, the plurality of teeth (60) are provided at a reverse angle from the teeth (52) and (54) of the cantilevered portion (48) of the ratchet (44). The telescopic arm (56) and ratchet (44) are preferably configured so as to allow the telescopic arm (56) to be moved through the opening (46) with the teeth (52) and (54) passing over the rack (58) but preventing the removal of the telescopic arm (56) from the opening (46) without the angled tab (50) being lifted to move the teeth (52) and (54) of the cantilevered portion (48) of the ratchet (44) clear of the rack (58) provided on the telescopic arm (56). The ratchet (44) and rack (58) combination may be of a standard “cable tie” arrangement with the ratchet (44) being releasable rather than of the typical permanent one-way variety. Coupled to the ends of the telescopic arms (56) and (62) are thin cylindrical fingers (64) and (66) integrally molded to the telescopic arms (56) and (62). Provided on the end of each of the fingers (64) and (66) is a ball (68) and (70) integrally molded thereto. The fingers (64) and (66) are preferably constructed of a sufficient rigidity to maintain their orientation against the weight of gravity.

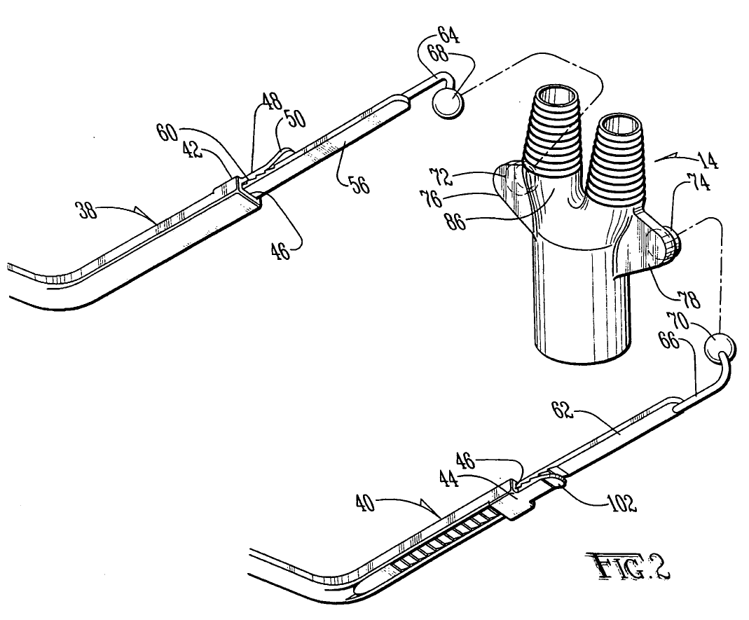

As shown in FIG. 2, the balls (68) and (70) are provided into cages (72) and (74) integrally formed on legs (76) and (78) of the supply tube keeper (14). As shown in FIG. 1, the curved legs (76) and (78) are integrally molded with an annular supply tube keeper (80). The supply tube keeper (80) may be of any suitable dimensions and constructed of any suitable materials. If desired, the supply tube keeper (80) may be annular and biased toward a resilient securement of a tube connector (82). The tube connector (82) is preferably a rigid biocompatible tube preferably having an interior diameter of twenty-two millimeters, with a first connection port (84) connected to a nasal interface (86). The nasal interface (86) may be of any type known in the art, including nasal cannula, nasal pillows or any desired nasal gas delivery system. If desired, the nasal interface (86) may be swivelly coupled to the connection port (84). The tube connector (82) is also provided with a second connection port (88) coupled by means of a swivel connection (90) to a gas supply tube (92). The gas supply tube (92) also preferably has an interior diameter of twenty-two millimeters to reduce turbulence as gas (94) transitions from the gas supply tube (92) to the tube connector (82) and the nasal interface (86). The gas supply tube (92) is provided with a standard lower connector interface (96) which, in turn, is coupled into fluid communication with a standard CPAP gas supply, such as those well known in the art.

Accordingly, when it is desired to utilize the nasal CPAP securement system (10) of the present invention, the user (28) provides the headgear (12) over the head (26). The user (28) secures the supply tube keeper (80) to the tube connector (82), which in turn is coupled to the nasal interface (86) and the gas supply tube (92). The user (28) places the nasal interface (86) within the nose (100) and pulls the telescopic arms (56) and (62) until the nasal interface (86) is secured as desired. The balls (68) and (70), and cages (72) and (74), allow the tube connector (82) and nasal interface (86) to move in multiple degrees of freedom relative to the user's head (26) while the user (28) sleeps. The balls (68) and (70), and cages (72) and (74), also allow the user (28) to lie sideways, with the gas supply tube (92) swiveling out of the way, while still maintaining the tube connector (82) secured to the supply tube keeper (80).

When it is desired to remove the headgear (12), the user pulls the angled tabs (50) and (102), thereby releasing the telescopic arms (56) and (62) so that the nasal interface (86) may be removed from the nose (100) of the user (28).

Although the invention has been described with respect to a preferred embodiment thereof, it is to be understood that it is not to be so limited since changes and modifications can be made therein which are within the full, intended scope of this invention as defined by the appended claims.

What is claimed is:

1. A nasal CPAP securement system comprising:
(a) a headgear;
(b) a supply tube keeper;
(c) a first swivel coupled between said headgear and said supply tube keeper; and
(d) a second swivel coupled between said headgear and said supply tube keeper.

2. The nasal CPAP securement system of claim 1, wherein said first swivel is a ball captured in a cage.

3. The nasal CPAP securement system of claim 2, wherein said headgear comprises:
(a) a support shoulder;
(b) a telescopic arm coupled to said support shoulder; and
(c) a second telescopic arm coupled to said support shoulder.

4. The nasal CPAP securement system of claim 3, wherein said supply tube keeper comprises:
(a) a tube coupler;
(b) a first leg coupled between said arcuate coupler and said first swivel; and
(c) a second leg coupled between said arculate coupler and said second swivel.

5. The nasal CPAP securement system of claim 4, wherein said tube coupler is annular.

6. The nasal CPAP securement system of claim 4, wherein said cage is provided on said first leg and wherein said ball is coupled to said first telescopic arm.

7. The nasal CPAP securement system of claim 6, further comprising a supplemental cage provided on said second leg and a supplemental cage coupled to said second telescopic arm.

8. The nasal CPAP securement system of claim 6, further comprising a lock coupled to said first telescopic arm and to said headgear.

9. The nasal CPAP securement system of claim 8, further comprising a supplemental lock coupled to said second telescopic arm and to said headgear.

10. The nasal CPAP securement system of claim 1, wherein said headgear comprises:
(a) a support shoulder;
(b) a first telescopic arm coupled to said support shoulder; and
(c) a second telescopic arm coupled to said support shoulder.

11. The nasal CPAP securement system of claim 10, further comprising a lock coupled to said first telescopic arm and to said headgear.

12. The nasal CPAP securement system of claim 11, wherein said lock comprises a ratchet.

13. The nasal CPAP securement system of claim 10, wherein said first swivel is a ball captured in a cage.

14. A nasal CPAP securement system comprising:
(a) a head securement system;
(b) a supply tube keeper; and
(c) a swivel coupled between said head securement system and said supply tube keeper.

15. The nasal CPAP securement system of claim 14, wherein said swivel is a ball captured in a cage.

16. The nasal CPAP securement system of claim 14, wherein said head securement system comprises a rack and a ratchet.

17. The nasal CPAP securement system of claim 14, further comprising a supplemental swivel coupled between said head securement system and said supply tube keeper.

18. A CPAP securement system comprising:
(a) a head securement system;
(b) a supply tube;
(c) a supply tube keeper coupled to said supply tube;
(d) a first swivel coupled between said head securement system and said supply tube keeper; and
(e) a second swivel coupled between said head securement system and said supply tube keeper.

19. The CPAP securement system of claim 18, wherein said first swivel comprises a first ball in a first cage and wherein said second swivel comprises a second ball in a second cage.

20. The CPAP securement system of claim 19, wherein said head securement system comprises a rack and a ratchet.
